(19) United States
(12) Patent Application Publication
(10) Pub. No.: US 2017/0286659 A1
(43) Pub. Date: Oct. 5, 2017

(54) BIOMETRIC AUTHENTICATION

(71) Applicant: Empire Technology Development LLC, Wilmington, DE (US)

(72) Inventor: Zhen Xiao, Beijing (CN)

(73) Assignee: Empire Technology Development LLC, Wilmington, DE (US)

(21) Appl. No.: 15/507,389

(22) PCT Filed: Aug. 29, 2014
(86) PCT No.: PCT/CN2014/085518

§ 371 Date: Feb. 28, 2017

(51) Int. Cl. G06F 21/32; G06K 9/00

(52) U.S. Cl. CPC G06F 21/32; G06K 9/00604; G06K 9/00087

(57) ABSTRACT

In an example biometric authentication system, a light beam generator may be configured to generate a light beam. The light beam may be projected to a retina of a user's eye and reflected from the retina. The reflected light beam may be directed, by an optical system, on to a holographic medium to form an input image. An image sensor may be configured to detect or sense the input image and further transmit the input image to an authenticator. The authenticator may be configured to compare the input image with a reference image and grant authentication for the user when the input image is determined to substantially match the reference image.

### TECHNICAL FIELD

The technologies described herein pertain generally to biometric authentication system based on an aberration of the user's eye.

### BACKGROUND

Unless otherwise indicated herein, the approaches described in this section are not prior art to the claims in this application and are not admitted to be prior art by inclusion in this section.

Aberrations on human eyes can be categorized into different types. Low order aberrations, such as nearsightedness, farsightedness, and astigmatism, may be corrected by prescription eyewear. However, high order aberrations such as spherical aberrations and coma aberrations may not be corrected. When a human eye is adjusted at an accommodation state to view an object, is has a unique aberration corresponding to the accommodation state.

### SUMMARY

Technologies are generally described relating to biometric authentication. The various techniques described herein may be implemented in various methods, systems, computer-executable programs, and/or computer-readable mediums.

In some examples, various embodiments may be implemented as methods. Some methods may include projecting, by a light beam generator, a light beam on to the eye of the user such that a reflected light beam is generated from the reflection of the light beam from the retina of the eye of the user; directing, by an optical system, the reflected light beam on to a holographic medium such that an input image is formed; detecting, by an image sensor, the input image formed by the reflected light beam and the holographic medium; comparing, by an authenticator, the input image formed by the reflected light beam to a reference image, wherein the reference image is associated with an authorized user; and granting, by the authenticator, authentication for the user when the input image is determined to substantially match the reference image.

In some examples, various embodiments may be implemented as systems. Some systems may include a light beam generator, configured to generate a light beam; a holographic medium; an optical system configured to receive a reflected light beam, and to direct the reflected light beam on to the holographic medium, wherein the reflected light beam corresponds to light reflected from the eye of the user; an image sensor configured to sense an input image produced by formation of a hologram from the reflected light when incident on the holographic medium; and an authenticator configured to compare the input image with a reference image, and grant authentication for the user when the input image is determined to substantially match the reference image.

In some examples, various embodiments may be implemented as computer readable mediums. Some computer-readable mediums may store instructions that, when executed, cause one or more processors to perform operations comprising recording a reference image using a retinal reflection of an authorized user, wherein the retinal reflection is incident on a hologram to generate the reference image; projecting a light beam on to a retina associated with an identity of a user; guiding a reflected light beam, reflected from the retina of the user, on to the hologram; generating an input image based on the reflected light beam incident on the hologram; and authenticating the identity of the user as the authorized user based on a comparison of the reference image and the input image.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

In the detailed description that follows, embodiments are described as illustrations only since various changes and modifications will become apparent to those skilled in the art from the following detailed description. The use of the same reference numbers in different figures indicates similar or identical items. In the drawings:

FIG. 1 shows an example system in which biometric authentication may be implemented;

FIG. 2 shows an example configuration of a computer device by which biometric authentication may be implemented;

FIG. 3 shows an example eye calibrator in which biometric authentication may be implemented;

FIG. 4 shows an example configuration of a processing flow of operations by which biometric authentication may be implemented;

FIG. 5 shows an example head mounted device by which biometric authentication may be implemented;

FIG. 6 shows an example change of aberrations of human eyes when biometric authentication may be implemented; and

FIG. 7 shows block diagram illustrating an example computing device that is arranged for biometric authentication, all arranged in accordance with at least some embodiments described herein.

### DETAILED DESCRIPTION

In the following detailed description, references are made to the accompanying drawings, which form a part of the description. In the drawings, similar symbols typically identify similar components, unless context dictates otherwise. Furthermore, unless otherwise noted, the description of each successive drawing may reference features from one or more of the previous drawings to provide clearer context and a more substantive explanation of the current example embodiment. Still, the embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein and illustrated in the drawings, may be arranged, substituted, combined, separated, and designed in a wide variety of different configurations, all of which are explicitly contemplated herein.

As referenced herein, an aberration may refer to a departure from ideal performance of a user's eye. An example of such a departure from ideal performance of a user's eye may include the wavefront of an incident light and a reflected light differing from each other. A wavefront of a light may refer to a locus of points of the light waves that have the same phase. Virtually every human is born with an optical aberration, to some degree, and each aberration has some unique characteristic. Thus, a wavefront of light may be reflected from each human eye differently than the incident light, and therefore may also be unique. Thus, in accordance with at least some examples described herein, the aberration may be utilized as a basis to identify user identity and to authenticate the user accordingly.

In some examples of biometric authentication, a light beam, e.g., a laser beam, may be projected on to a user's eye and may then be reflected back from the retina of the same eye. The reflection of the light beam may be affected by the aberration of the eye, for example due to the aforementioned uniqueness of the user's optical aberration. The reflected light beam may then be directed on to a holographic medium to form an input image. The input image may be detected and further compared with a previously stored reference image. Due to the characteristics of a holographic medium, the holographic medium may be designed to generate an image that matches the reference image based on a reflection of a light with a specific aberration. An authenticator may authenticate the user if the input image matches the reference image; alternatively, the authenticator may deny authentication if the input image does not match the reference image. In some examples, biometric identification may be achieved based upon the person's unique eye aberration (for either or both of the eyes).

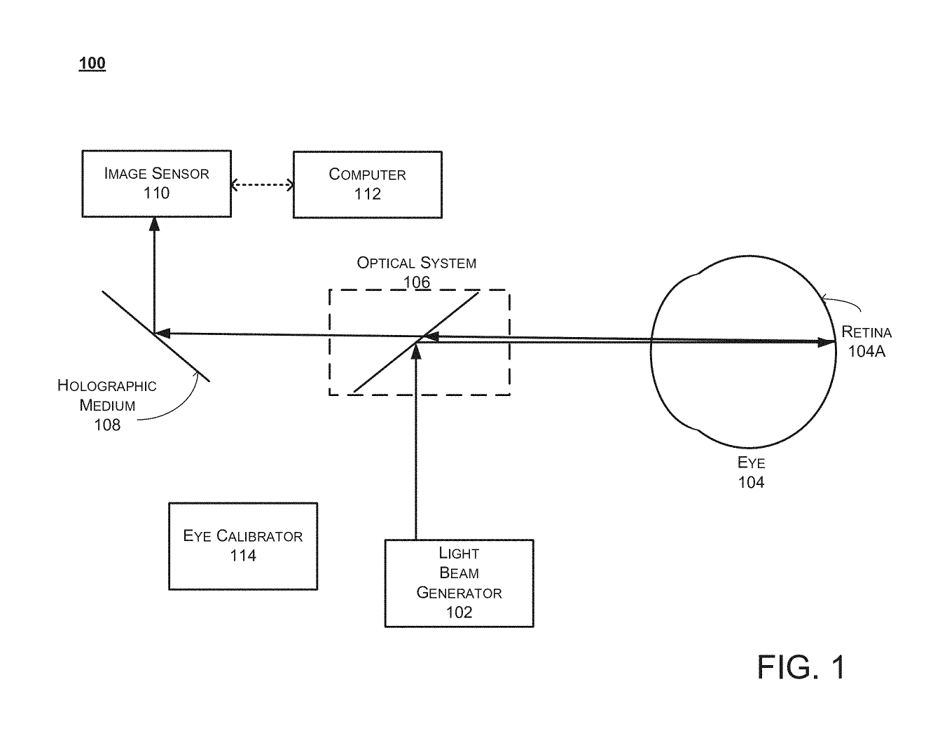

FIG. 1 shows an example system 100 in which biometric authentication may be implemented, arranged in accordance with at least some embodiments described herein. As depicted, example system 100 may include, at least, a light beam generator 102, an eye 104 that includes a retina 104A, an optical system 106, a holographic medium 108, an image sensor 110, a computer device 112, and an eye calibrator 114.

Light beam generator 102 may refer to a device configured to generate a light beam of a predetermined wavelength. The light beam of predetermined length may be utilized as a basis for a security system, i.e., determining the identity of the user based on a scan of eye 104. Since the light beam may be projected directly or indirectly to eye 104, the predetermined wavelength may be chosen to be infrared, i.e., longer than 700 nm, so that the light beam is invisible to a user and may be less harmful to eye 104.

The optical characteristics of the light beam may be customized to provide additional features to example system 100. In some examples, the light beam may be generated as collimated light. Alternatively, a complex amplitude of the light beam may be modulated by optical gratings such that information may be carried by the modulated complex amplitude. Such information may convey a purpose of the light beam, e.g., verifying the user's identity, to a receiving device, e.g., image sensor 110. The generated light beam may be projected to optical system 106.

Light beam generator 102 may refer to any light emitting source that is capable of providing the light beam at the predetermined wavelength. In at least one example embodiment, light beam generator 102 may refer to a general purpose laser (Light Amplification by Stimulated Emission of Radiation) beam generator such that the wavelength of the light beam may be precisely controlled at a fixed wavelength. The general purpose laser beam generator may include a gain medium, a laser pumping power supply, a high reflector, an output coupler, etc. Further, light beam generator 102 may include a beam expander to expand the diameter of the light beam, for example so that the beam diameter of the light beam is in some examples in the range 2 mm-10 cm, in some examples approximately equal to that of an eye pupil, and in some examples substantially similar to the diameter of eye 104. In at least some examples, light beam generator 102 may be mounted on a head mounted device (HMD), e.g., a helmet, goggles, etc. Thus, the position of eye 104 relative to light beam generator 102 may be fixed.

Optical system 106 may refer to one or more, for example a group, of half-reflecting mirrors that may be positioned to direct the generated light beam on to eye 104. The one or more half-reflecting mirrors may allow a portion of the generated light beam to pass through the half-reflecting mirrors and other portions of the generated light beam to be reflected from the surfaces of the half-reflecting mirrors. By adjusting the position of the half-reflecting mirrors, optical system 106 may be configured to direct or guide the light beam generated by light beam generator 102 on to retina 104A of eye 104. In at least some examples, optical system 106 may also be mounted on the aforementioned head mounted device (HMD).

Eye 104 may refer to eye of a user/person or animal attempting to satisfy a biometric security requirement. Biometric authentication, in accordance with some examples described herein, may exploit, for instance, the ability of eye 104 to collect and focus light to form an image on retina 104A. Since each eye has a unique wavefront aberration, reflection from a respective retina may be a basis for the biometric authentication. That is, if the reflection from eye 104 forms an input image that matches a recorded reference image, eye 104 may be deemed to be an eye of an authorized user and, accordingly, authentication may be granted for the user of eye 104. Portions of the light beam may be reflected from retina 104A and may be further directed onto holographic medium 108.

Holographic medium 108 may refer to a medium, a reflection from which may form an image, responsive to exposure thereof under a specific light beam of a wavefront aberration. Non-limiting examples of the medium may include a photographic material (e.g., photographic emulsions, dichromated gelatin, photoresists, photothermoplastics, photopolymers, photorefractives) with an amount of light-reactive grains. In other examples, a holographic medium may include an electronic display, such as a spatial light modulator (SLM). In general, due to the characteristics of a holographic medium, when holographic medium 108 is exposed under a light beam, the reflection from the surface of holographic medium 108 may form an image corresponding to the light beam. In other words, other light beams will not result in the same image. Thus, such strict correspondence between a light beam and a corresponding image may provide a basis for an authentication system. The image corresponding to the light beam may be further input to computer device 112 (“input image” hereafter) to be compared to a reference image.

As mentioned here, a reference image, as a benchmark for the comparison, may refer to an image formed by a reflection, from the surface of holographic medium 108, caused by a light beam reflected from a retina of an authorized user's eye. The reference image may be formed as described below. In at least some examples, light beam generator 102 may be configured to project the light beam towards an eye of an authorized user to obtain the light reflected from the retina of the authorized user's eye (“retinal reflection” hereafter). Subsequently, the retinal reflection may be directed by optical system 108 on to holographic medium 108. A predesigned interference pattern imprinted on holographic medium 108 may interfere with the retinal reflection of the authorized user's eye to form the reference image. As indicated by the principle of holography, the reference image recorded on a holographic medium can only be constructed under a light beam identical to the retinal reflection of the authorized user's eye. Thus, when holographic medium 108 is exposed under light beams other than the reference light beam, the formed input images may not match the reference image.

In some examples of the reference image, the reference image may further include at least two sub-images, each of which may be detected at a respective angle relative to holographic medium 108. For example, the reference image may include a cube that further includes two barcodes on two adjacent surfaces of the cube. Each of the two barcodes may be viewable beginning at a specific angle relative to holographic medium 108. An additional embodiment of image sensor 110 may be positioned at another angle to detect the reference image with the primary embodiment of image sensor 110.

In further examples, multiple reference images, which may be respectively associated with multiple authorized users, may be stored in a data storage or a database associated with computer 112. Alternatively or additionally, each of the multiple reference images may be associated with an authorized user's eye having different focal points, which may be based on different target positions either in spatial depth or in axial position relative to the authorized user's eye.

In some other examples of holographic medium 108, holographic medium 108 may be pre-generated or designed, by a computer device, in accordance with a light beam reflected from an eye of an authorized user. For example, an interference pattern may be pre-generated by computer device 112 and imprinted on holographic medium 108 such that the interference pattern may recreate the reference image under the light beam reflected from a retina of an authorized user's eye.

Image sensor 110 may refer to a device that may be configured to detect or capture the input images formed by holographic medium 108. In some examples, image sensor 110 may be configured to detect or capture the two sub-images at two different angles relative to holographic medium 108. Non-limiting examples of components of image sensor 110 may include one or more lenses, one or more CCD/CMOS sensors, one or more shutters, one or more data exchange module, etc. The detected image may be transmitted to computer device 112.

Computer 112 may refer to a general purpose computer, portions of which may be configured to compare the captured input image with the reference image associated with the authorized user. The reference image may be previously stored in a database associated with computer 112. Further, computer device 112 may be configured to grant authentication for the user when the input image is determined to substantially match the reference image and to deny authentication when the input image is determined to fail to match the reference image. Non-limiting examples of computer 112 may include a personal computer, a laptop, a phone, a tablet, etc.

In at least some examples, the comparison between two images may be based on one of multiple existing image comparison algorithms. Such image comparison algorithms may enable two or more images to be compared resulting in a determination of whether the images are similar to each other. A threshold resemblance, upon which the input image and the reference image may be deemed to match, may be predetermined by a system administrator. For example, when a resemblance between the input image and the reference image is greater than a predetermined threshold value of 97%, the input image may be determined to substantially match the reference image.

In further examples, multiple reference images, which may be respectively associated with multiple authorized users, may be stored in the database associated with computer 112. Alternatively or additionally, each of the multiple reference images may be associated with an authorized user's eye with different focal points, e.g., when the authorized user looks at objects at different distance relative to him/her.

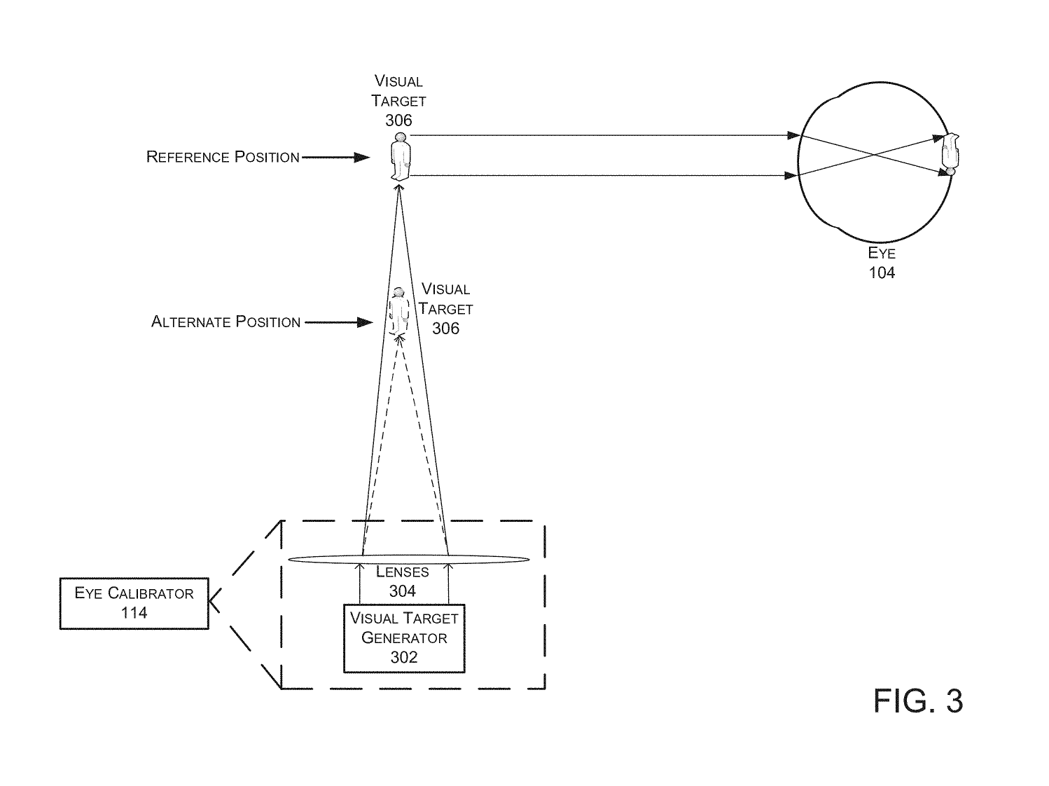

Eye calibrator 114 may refer to a device that may be configured to provide a visual target to pre-adjust eye 104 prior to the input image and the reference image are formed. In some examples of the pre-adjustment, the visual target may be provided at a reference position when the input image and the reference image are formed such that eye 104 may be pre-adjusted to a reference accommodation state. Further, eye calibrator 114 may also be mounted on the aforementioned head mounted device (HMD). Eye calibrator 114 is described in greater details in accordance with FIG. 3.

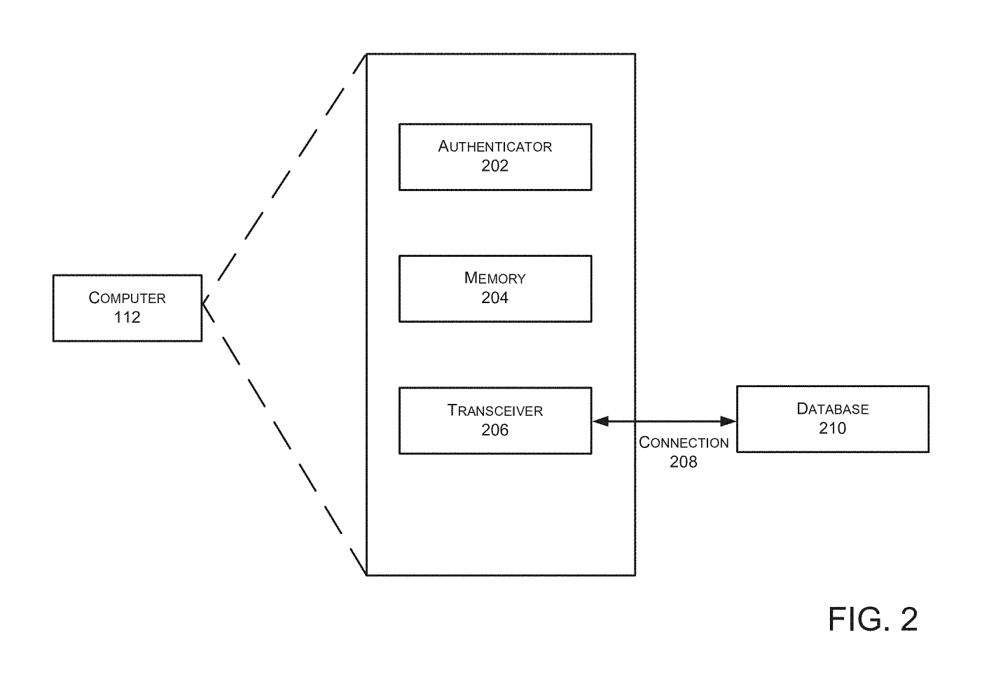

FIG. 2 shows an example configuration of computer 112 by which biometric authentication may be implemented, arranged in accordance with at least some embodiments described herein. As depicted, the example configuration of computer 112 may include, at least, an authenticator 202, a memory 204, a transceiver 206 communicatively coupled to a database 210 via a connection 208.

Authenticator 202 may refer to a component that may be configured to compare the input image to the reference image, and further grant or deny authentication for the user based on the result of the comparison. The input image may be received from image sensor 110, and the reference image may be previously stored in memory 204 or database 210. As stated above, the comparison between two images may be conducted in accordance with the aforementioned image comparison algorithms. Further, authenticator 202 may be configured to authenticate the user when the input image is determined to substantially match the reference image and to deny authentication when the input image is determined to fail to match the reference image. For example, when a resemblance between the input image and the reference image is greater than the predetermined value of 97%, the input image may be determined to substantially match the reference image and, accordingly, authenticator 202 may be configured to authenticate the user. The calculation of the resemblance may be conducted in accordance with some currently existing image comparison algorithms. Such image comparison algorithms may include, for example, key point matching, histogram comparison, etc. For example, in accordance with key point matching algorithm, authenticator 202 may randomly select 1,000 points (or pixels) from the reference image to compare to 1,000 points in the input image at the corresponding positions. The resemblance may refer to the count of matching points between the two sets of 1,000 points respectively selected from the reference image and the input image. A predetermined value of 97% may represent that at least 970 out of the 1,000 points are matching. In accordance with various embodiments, authenticator 202 may be implemented as hardware, software, firmware, or any combination thereof.

Memory 204 may refer to a data storage that may be configured to store, at least, the reference image. In at least one example, memory 204 may be integrated in computer device 112 as a component thereof, e.g., memory or hard drive of a computer, or a data storage device removably coupled to computer device 112, e.g., a USB disk or a CD-ROM.

Transceiver 206 may refer to a component that may be configured to retrieve the reference image from database 210 via connection 208. Non-limiting examples of transceiver 206 may include Ethernet adapter. Wi-Fi® adapter. Bluetooth® controller, etc.

Connection 208 may refer to a data link between computer device 112 and database 210. Non-limiting examples of connection 208 may include Wi-Fi™, wireless local area network (WLAN or IEEE 802.11), WiMAX® (Worldwide Interoperability for Microwave Access), Bluetooth™, hard-wired connections, e.g., cable, phone lines, or in accordance with other analog and digital wireless voice and data transmission technologies.

Database 210 may refer to an organization of data that includes the reference image. In at least some examples, database 210 may be stored on a memory of a remote server and accessible over connection 208. Similar to memory 204, the memory may be associated with computer device 112 as a component thereof, e.g., memory or hard drive of a computer, or a data storage device removably coupled to computer device 112, e.g., a USB disk or a CD-ROM.

FIG. 3 shows an example eye calibrator 114 in which biometric authentication may be implemented, arranged in accordance with at least some embodiments described herein.

In general, an aberration of an eye may vary when the eye focuses on targets at different distances relative to the eye. For example, the aberration of eye 104 is different when eye 104 focuses on visual target at the alternate position and the reference position as illustrated in FIG. 3. Thus, eye 104 may be pre-adjusted to a reference state before the input image and the reference image are formed. Thus, visual target 306 may be generated, by visual target generator 302, to be viewed by eye 104 at the reference position when the reference image and the input image are formed. Eye calibrator 114 may be configured to generate such visual target. In some examples, eye calibrator 114 may be integrated with example system 100 in a same physical housing. As depicted, eye calibrator 114 may include, at least, a visual target generator 302, one or more lenses 304, and a visual target 306.

Visual target generator 302 may refer to a device that may be configured to project a visual target at a distance to eye 104. Non-limiting examples of visual target generator may include projectors, LCD screens, etc. In some other examples, visual target generator 302 may refer to a non-optical device with a tangible target. The distance between the tangible target and eye 104 may be physically adjusted, e.g., via an adjustable mount. Visual target generator 302 may be mounted on the aforementioned head mounted device (HMD), e.g., a helmet, goggles, etc.

Lenses 304, as a part of eye calibrator 114, may refer to one or more lenses associated with visual target generator 302 and configured to adjust a position of visual target 306. For example, by changing distance between lenses 304, visual target 306 may be displayed at different positions relative to eye 104.

Visual target 306 may refer to an image generated to be viewed by eye 104. The position of visual target 306 may be adjusted optically by lenses 304 or physically by the adjustable mount. Thus, when eye 104 focuses on visual target 306, eye 104 is adjusted to a reference state such that factors that may affect the aberration of eye 104 may be eliminated. In a non-limiting example, visual target generator 302 may be integrated with a helmet. When a user wears the helmet, visual target generator 302 may be configured to project visual target 306 at a distance, e.g., 20 cm, from eye 104 for eye 104 to focus on.

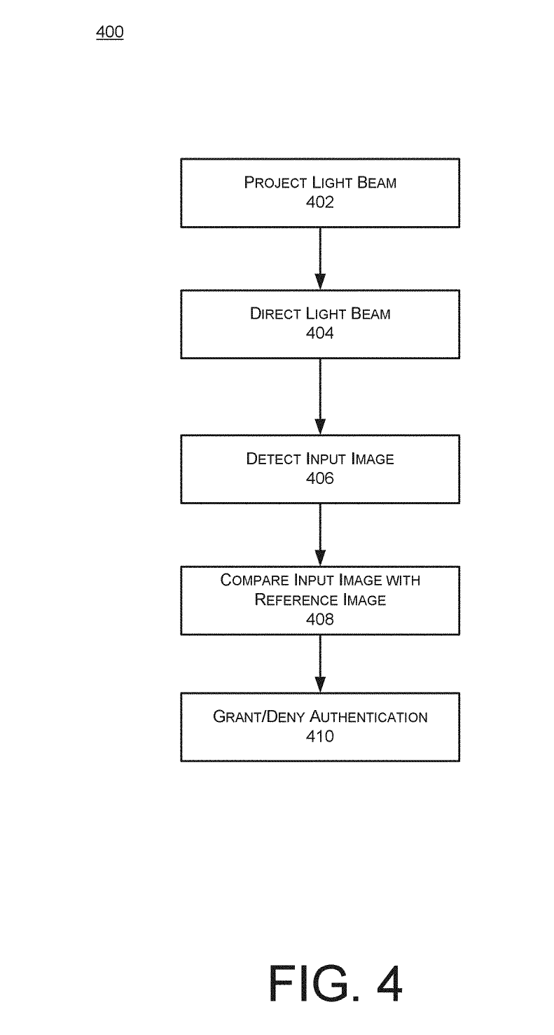

FIG. 4 shows an example configuration of a processing flow 400 of operations by which biometric authentication may be implemented, arranged in accordance with at least some embodiments described herein. As depicted, processing flow 400 may include sub-processes executed by various components that are part of example system 100. However, processing flow 400 is not limited to such components, and modification may be made by re-ordering two or more of the sub-processes described here, eliminating at least one of the sub-processes, adding further sub-processes, substituting components, or even having various components assuming sub-processing roles accorded to other components in the following description. Processing flow 400 may include various operations, functions, or actions as illustrated by one or more of blocks 402, 404, 406, 408, and/or 410. Processing may begin at block 402.

Block 402 (Project Light Beam) may refer to light beam generator 102 projecting a light beam on to eye 104 of the user such that retinal reflection from retina 104A of eye 104 may be obtained. The light beam may of a predetermined wavelength as a basis for further determination of the identity of the user, i.e., determination of whether eye 104 is an eye of an authorized user. The light beam of the predetermined wavelength may refer to an infrared laser beam, i.e., wavelength being longer than 700 nm, so that the light beam may not be disturbing to the user since infrared light is invisible. Light beam generator 102 and optical system 106 may be together mounted on a head mounted device (HMD), e.g., a helmet, goggles, etc. Block 402 may be followed by block 404.

Block 404 (Direct Light Beam) may refer to optical system 106 directing the retinal reflection of eye 104 on to holographic medium 108 such that an input image may be formed based on the interference of the retinal reflection and an interference pattern imprinted on holographic medium 108. As described above, optical system 106 may refer to a group of half-reflecting mirrors that may allow a portion of the generated light beam to pass through the half-reflecting mirrors and other portions to reflect from the surfaces of the half-reflecting mirrors. By adjusting the position of the half-reflecting mirrors, optical system 106 may be configured to direct or guide the light beam generated by light beam generator 102 on to retina 104A of eye 104 to obtain the retinal reflection and, further, to direct the retinal reflection on to holographic medium 108.

If the retinal reflection of eye 104 bears the same wavefront aberration as the retinal reflection of an authorized user, the retinal reflection of eye 104 and holographic medium 108 may form the input image that matches a reference image. Otherwise, the input image may not match the reference image. The reference image may refer to an image formed by holographic medium 108 and a retinal reflection of an authorized user's eye. That is, a predesigned interference pattern imprinted on holographic medium 108 may form the reference image under the retinal reflection of an authorized user's eye. Block 402 may be followed by block 404.

Block 406 (Detect Input Image) may refer to image sensor 110 detecting the input image formed by the retinal reflection of eye 104 and holographic medium 108. Non-limiting examples of components of image sensor 110 may include one or more lenses, one or more CCD/CMOS sensors, one or more shutters, one or more data exchange module, etc. The detected image may be transmitted to computer device 112 and may be processed by one or more image processing applications executing on computer device 112. Such image processing applications may include image enhancing, edge detecting, auto-balancing, etc. Block 406 may be followed by block 408.

Block 408 (Compare Input Image with Reference Image) may refer to authenticator 202 comparing the input image with the reference image. The reference image may be previously stored in a database associated with computer 112, Non-limiting examples of computer 112 may include a personal computer, a laptop, a tablet, a phone, etc.

In at least some examples, the comparison between the input image and the reference image may be conducted in accordance with multiple existing image comparison algorithms and a threshold resemblance that may be predetermined by a system administrator. As in a previously used example, when a resemblance between the input image and the reference image is greater than the predetermined value of 97%, the input image may be determined to substantially match the reference image. Block 408 may be followed by block 410.

Block 410 (Grant/Deny Authentication) may refer to authenticator 202 granting authentication for the user when the input image is determined to substantially match the reference image, or deny authentication for the user when the input image is determined to fail to match the reference image. Further to the above example, when a resemblance between the input image and the reference image is greater than the predetermined value of 97%, the input image may be determined to substantially match the reference image and, accordingly, authenticator 202 may be configured to authenticate the user.

One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

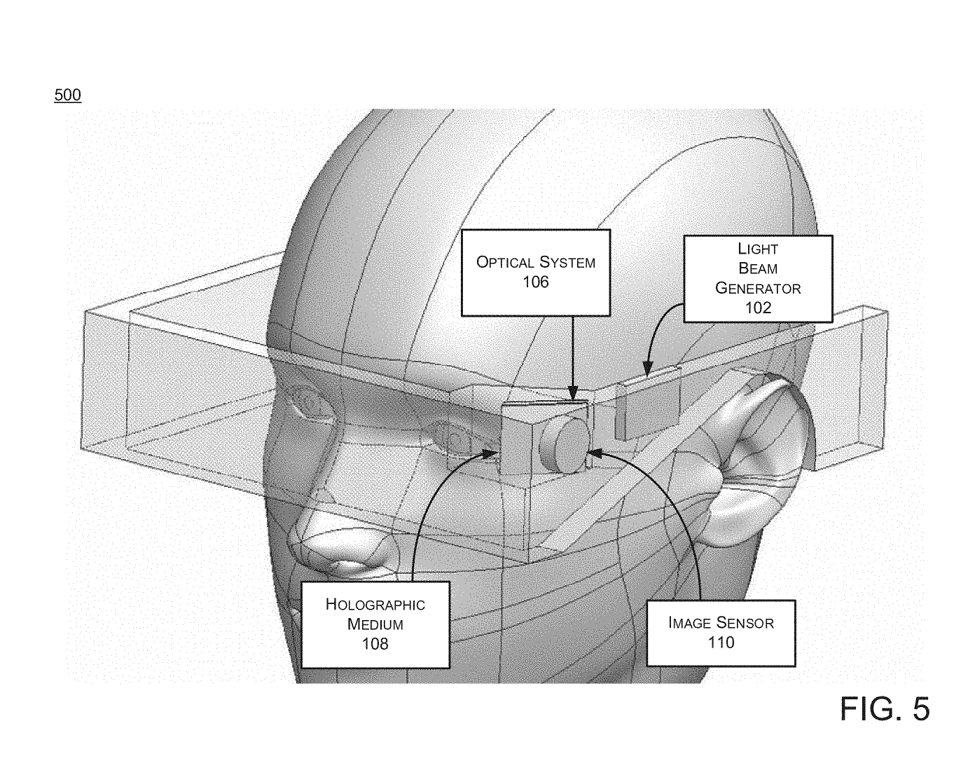

FIG. 5 shows an example head mounted device 500 by which biometric authentication may be implemented, arranged in accordance with at least some embodiments described herein. As depicted, example head mounted device 500 may include light beam generator 102, optical system 106, holographic medium 108, and image sensor 110.

As described above, light beam generator 102 may refer to any light emitting source that provides a light beam at a predetermined wavelength. The light beam may be projected on to optical system 106. Optical system 106 may refer to a group of half-reflecting mirrors that direct the light beam on to retina 104A of eye 104. The light beam reflected from retina 104A may be directed on holographic medium 108. The reflection from holographic medium 108 may form an image, as a basis for the biometric authentication, which may be captured by image sensor 110. That is, if the image is same or substantially similar to a reference image, the user, to which eye 104 belongs, may be authenticated as an authorized user.

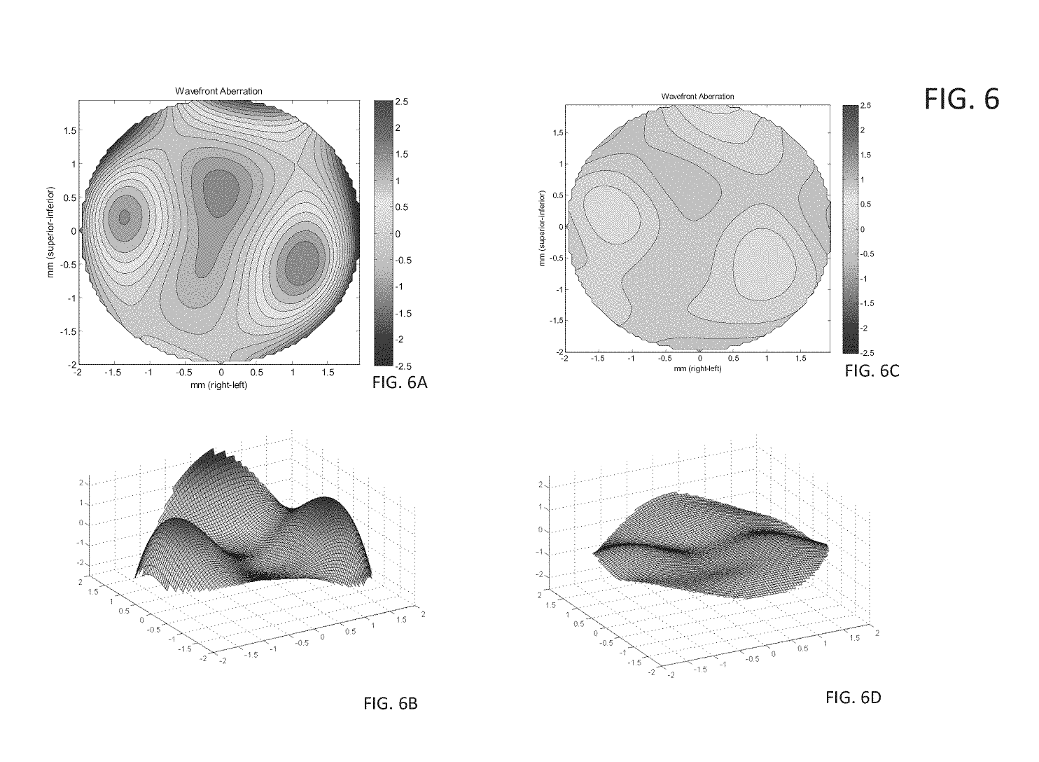

FIG. 6 shows an example change of aberrations of human eyes when biometric authentication may be implemented, arranged in accordance with at least some embodiments described herein. FIGS. 6A and 6B depict the example wavefront aberration of eye 104 when eye 104 focuses on visual target 306 at the alternate position. FIGS. 6C and 6D depict the example wavefront aberration of eye 104 when eye 04 focuses on visual target 306 at the reference position.

In FIGS. 6A and 6C, the bottom axis and the left axis represent the two dimensions of eye 104 and the right bar indicates the correlation between the grey levels and the example wavefront aberration. In FIGS. 6B and 6D, the triplet of axes that are pair-wise perpendicular respectively represent the two dimensions of eye 104 and the wavefront aberration.

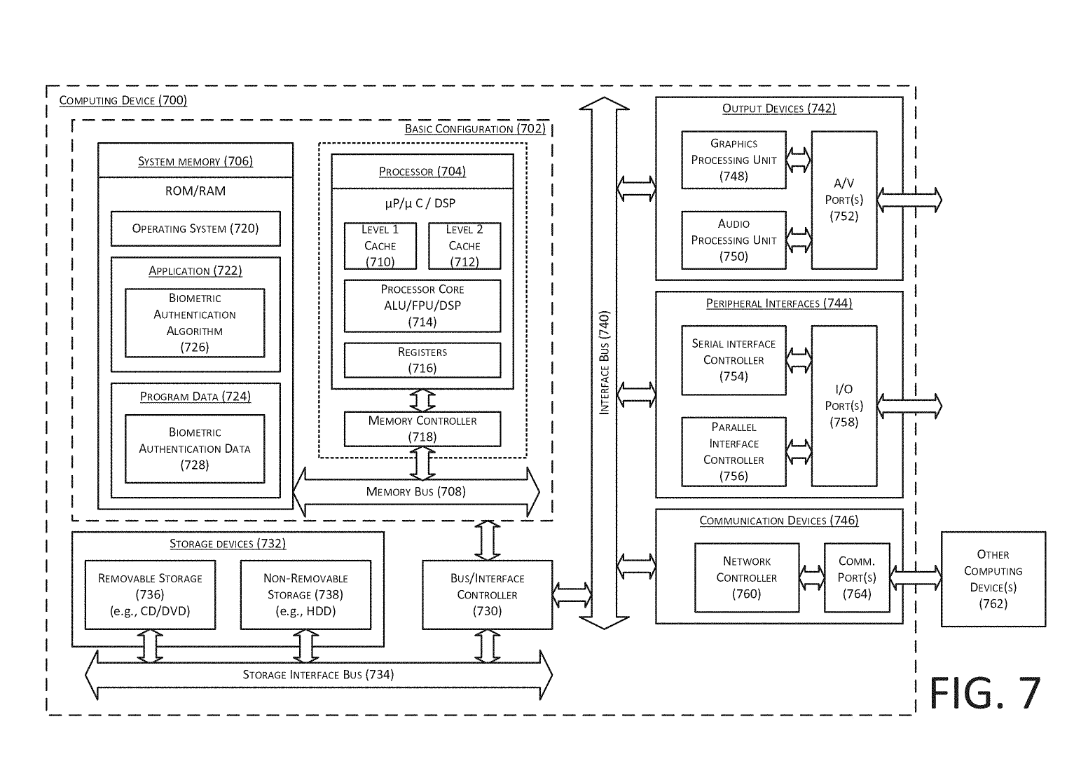

FIG. 7 shows block diagram illustrating an example computing device that is arranged for biometric authentication, arranged in accordance with at least some embodiments described herein.

In a very basic configuration 702, computing device 700 typically includes one or more processors 704 and a system memory 706. A memory bus 708 may be used for communicating between processor 704 and system memory 706.

Depending on the desired configuration, processor 704 may be of any type including but not limited to a microprocessor (pP), a microcontroller (pC), a digital signal processor (DSP), or any combination thereof. Processor 704 may include one more levels of caching, such as a level one cache 710 and a level two cache 712, a processor core 714, and registers 716. An example processor core 714 may include an arithmetic logic unit (ALU), a floating point unit (FPU), a digital signal processing core (DSP Core), or any combination thereof. An example memory controller 718 may also be used with processor 704, or in some implementations memory controller 718 may be an internal part of processor 704.

Depending on the desired configuration, system memory 706 may be of any type including but not limited to volatile memory (such as RAM), non-volatile memory (such as ROM, flash memory, etc.) or any combination thereof, System memory 706 may include an operating system 720, one or more applications 722, and program data 724. Application 722 may include a biometric authentication algorithm 726 that is arranged to perform the functions as described herein including those described with respect to process 400 of FIG. 4. Program data 724 may include biometric authentication data 728 that may be useful for operations, e.g., image comparison, pattern recognition, image enhancing, etc., with biometric authentication algorithm 726 as is described herein. In some embodiments, application 722 may be arranged to operate with program data 724 on operating system 720 such that implementations of biometric authentication may be provided as described herein. This described basic configuration 702 is illustrated in FIG. 7 by those components within the inner dashed line.

Computing device 700 may have additional features or functionality, and additional interfaces to facilitate communications between basic configuration 702 and any required devices and interfaces. For example, a bus/interface controller 730 may be used to facilitate communications between basic configuration 702 and one or more data storage devices 732 via a storage interface bus 734. Data storage devices 732 may be removable storage devices 736, non-removable storage devices 738, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media may include volatile and nonvolatile, removable and non-removable media implemented in any method or technology for storage of information, such as computer readable instructions, data structures, program modules, or other data.

System memory 706, removable storage devices 736 and non-removable storage devices 738 are examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by computing device 700. Any such computer storage media may be part of computing device 700.

Computing device 700 may also include an interface bus 740 for facilitating communication from various interface devices (e.g., output devices 742, peripheral interfaces 744, and communication devices 746) to basic configuration 702 via bus/interface controller 730. Example output devices 742 include a graphics processing unit 748 and an audio processing unit 750, which may be configured to communicate to various external devices such as a display or speakers via one or more A/V ports 752. Example peripheral interfaces 744 include a serial interface controller 754 or a parallel interface controller 756, which may be configured to communicate with external devices such as input devices (e.g., keyboard, mouse, pen, voice input device, touch input device, etc.) or other peripheral devices (e.g., printer, scanner, etc.) via one or more I/O ports 758. An example communication device 746 includes a network controller 760, which may be arranged to facilitate communications with one or more other computing devices 762 over a network communication link via one or more communication ports 764.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

Computing device 700 may be implemented as a portion of a small-form factor portable (or mobile) electronic device such as a cell phone, a personal data assistant (PDA), a personal media player device, a wireless web-watch device, a personal headset device, an application specific device, or a hybrid device that include any of the above functions. Computing device 700 may also be implemented as a personal computer including both laptop computer and non-laptop computer configurations.

In an illustrative embodiment, any of the operations, processes, etc, described herein can be implemented as computer-readable instructions stored on a computer-readable medium. The computer-readable instructions can be executed by a processor of a mobile unit, a network element, and/or any other computing device.

There is little distinction left between hardware and software implementations of aspects of systems; the use of hardware or software is generally (but not always, in that in certain contexts the choice between hardware and software can become significant) a design choice representing cost vs, efficiency tradeoffs. There are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; if flexibility is paramount, the implementer may opt for a mainly software implementation; or, yet again alternatively, the implementer may opt for some combination of hardware, software, and/or firmware.

In some embodiments, a method for authenticating an identity of a user comprises projecting, by a light beam generator, a light beam on to the eye of the user such that a reflected light beam is generated from the reflection of the light beam from the eye of the user. In some embodiments, reflection may occur from the retina and/or cornea. The light beam generator may include a laser, light emitting diode, or other light source. Projecting a light beam on to the eye of a user may include directing the light beam using a reflective element (e.g. a mirror such as a partially transmissive mirror through which, in some embodiments, reflected light may pass), a refractive element (such as a lens, prism, and the like), an electrooptical beam steering device, diffractive element, and the like, or some combination of optical elements. An example method may further comprise directing, by an optical system, the reflected light beam such that an input image is formed. In some embodiments, the optical system may include one or more of the optical elements used for projecting the light beam onto the eye of the user. The reflected light beam (the light beam reflected from the eye of the user) may be reflected from or transmitted through a holographic medium so as to form an input image on an image sensor. In some embodiments, a reflected image may be formed directly from reflected light without using a holographic medium.

In some embodiments, a method to help authenticate the identity of a subject comprises detecting, by an image sensor, the input image formed by the reflected light beam, reflected from an eye of the user, and comparing, by an authenticator, the input image formed by the reflected light beam to a reference image, wherein the reference image is associated with an authorized user. Hence, a person can be identified as an authorized user if the input image is sufficiently similar to the reference image. For example, a person may provide an identity, allow an input image to the sensed, and the input image may then be compared to a reference image for the provided identity. The comparison of the images may provide an image similarity parameter, which may need to be above a predetermined threshold level for authentication. Authentication may include other aspects, such as combining image authentication as described herein with a one or more of a retinal scan, password or personal identification number input, eye color detection, fingerprint input, or other security related input.

In some examples, a method for authenticating an identity of a user comprises reflecting a light beam from an eye of the user, forming an input image using a reflected light beam generated from the reflection of the light beam from the eye of the user (for example, from the retina of the eye), and comparing the input image (or data obtained therefrom, such as eye aberration data) with a reference image (or reference data obtained therefrom, such as reference aberration data). In some embodiments, aberration data may be determined for the eye of the user from the input image, and authentication granted when the aberration data substantially matches the reference aberration data obtained for the eye of an authorized user. In some embodiments, the method may include granting, by the authenticator, authentication for the user when the input image is determined to substantially match the reference image. Granting authentication may include allowing a person to perform one or more of the following: enter a secure location, operate machinery, obtain money, complete a purchase, and the like.

In some embodiments, an identity authentication system is configured to authenticate a user, and comprises a light beam generator, configured to generate a light beam, such as an electroluminescent device such as a light emitting diode, a laser, or other light emitting device. An example system may further include an image sensor configured to sense an input image. The input image is formed using a reflected light beam, wherein the reflected light beam is generated from a reflection of the light beam from the eye of the user, for example from the retina of the eye. An optical system is configured to project the light beam onto the eye, receive at least some of the reflected light beam, and to direct the reflected light beam to form an input image at the image sensor. For example, the optical system may be configured to direct the light beam onto a holographic medium, an interaction between the reflected light beam and the holographic medium forming the input image at the image sensor. In some examples, a system may further include an authenticator configured to grant authentication for the user based on the input image. In some embodiments, the authenticator may be a separate device. For example, an identity authentication system may be configured to transmit the input image or input image data derived therefrom to the authenticator, and receive authentication data from the authenticator. For example, communication may be over a wired or wireless connection with the authenticator. Authentication may require a substantial match between aberration data for a user eye and reference aberration data for an authorized person's eye, in some embodiments for similar (or, in some cases, a plurality) of eye accommodations.

In some embodiments, an authenticator may be configured to compare the input image to a reference image, and grant authentication for the user when the input image is determined to substantially match a reference image. In some examples, the authenticator is configured to determine identity parameters (such as aberration data) from the input image and to compare the identity parameters to reference identity parameters (such as reference aberration data). The identity parameters may include one or more optical aberrations of the eye of the user, iris images, retinal images, and the like. The optical aberrations of the user eye may be identified and quantified, based on the input image, to generate aberration data. In some examples, the authenticator is configured to determine one or more optical aberrations in the eye of the user from the input image, and compare the one or more aberrations to reference aberration data. Aberration data may include Zemike polynomial numbers and coefficients, and determination and quantification of astigmatism and other optical aberrations, for example as known in the eye arts. The authenticator may grant authentication for the user only when the aberration data is determined to substantially match the reference aberration data.

In some embodiments, an authenticator may be configured to grant authentication for the user based on a detected optical aberration of the eye of the user determined from the input image. The detected optical aberration may be compared to a reference optical aberration already determined for the eye of an authorized user. Authentication may require obtaining an input image from one or both eyes, and may in some examples require similar accommodation states of user and authorized eyes for data comparison.

In some embodiments, the focus of the eye of the user (accommodation) may be determined, for example from the input image or otherwise determined, and used to select a reference image for comparison. In some embodiments, a reference image may be obtained from an authorized user wearing and/or not wearing corrective lenses.

In some embodiments, an identity authentication system may be a unitary device, for example a hand-held device including the light beam generator, the optical system, and the image sensor. Optionally, the device may further include the authenticator. In some examples, an identity authentication system may be part of a security system associated with a building (or component thereof, such as a door, elevator, and the like), vehicle, financial security system, and the like. In some embodiments, the holographic medium may be embossed on a credit card and used to direct reflected light from a user eye to an image sensor for authentication of the user.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc.; and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein can be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity; control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations), Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

1. A method for authenticating an identity of a user, the user having an eye including a retina, the method comprising:
projecting, by a light beam generator, a light beam on to the eye of the user such that a reflected light beam is generated from a reflection of the light beam from the retina of the eye of the user;
directing, by an optical system, the reflected light beam on to a holographic medium such that an input image is formed;
detecting, by an image sensor, the input image formed by the reflected light beam and the holographic medium;
comparing, by an authenticator, the input image formed by the reflected light beam to a reference image, wherein the reference image is associated with an authorized user; and
granting, by the authenticator, authentication for the user when the input image is determined to substantially match the reference image.

2. The method of claim 1, further comprising pre-adjusting the eye to a reference state, prior to the projecting, by:
generating an image of a visual target to be viewed by the user at a first reference position; and
changing a position of the image to a second reference position.

3. The method of claim 1, wherein projecting the light beam further comprises expanding the light beam to form an expanded light beam, a beam diameter of which is substantially close to a diameter of the eye, and projecting the expanded light beam towards the eye of the user.

4. The method of claim 1, wherein comparing the input image formed by the reflected light beam to the reference image further comprises:
comparing the input image to the reference image, wherein the input image is associated with a first focal point of the eye relative to the light beam; and
comparing a second input image with a second reference image, wherein the second input image is associated with a second focal point of the eye relative to the light beam, wherein the first and second focal points of the eye are different from each other.

5. The method of claim 1, further comprising generating the reference image by capturing at least two holographic images at least two directions relative to the holographic medium to generate the reference image.

6. (canceled)

7. The method of claim 1, further comprising denying authentication for the user when the input image is determined to fail to substantially match the reference image.

8. The method of claim 1, further comprising obtaining the reference image by:
projecting the light beam towards an authorized eye of the authorized user such that a retinal reflection is obtained from light reflected by the authorized eye responsive to the projected light beam; and
directing the retinal reflection towards the holographic medium such that the reference image is obtained from formation of a hologram with the retinal reflection of the authorized eye.

9. An identity authentication system configured to authenticate a user, the user having an eye including a retina, the identify authentication system comprising:
a light beam generator, configured to generate a light beam;
a holographic medium;
an optical system configured to receive a reflected light beam, and to direct the reflected light beam on to the holographic medium, wherein the reflected light beam corresponds to light reflected from the eye of the user;
an image sensor configured to sense an input image produced by formation of a hologram from the reflected light when incident on the holographic medium; and
an authenticator configured to:
compare the input image with a reference image, and
grant authentication for the user when the input image is determined to substantially match the reference image.

10. (canceled)

11. (canceled)

12. The identity authentication system of claim 9, further comprising:
a visual target generator, configured to generate a visual target having an apparent target location, wherein the visual target is viewable at the apparent target location from a viewing location along the light beam; and
one or more lenses associated with the visual target configured to modify the apparent target location, the apparent target location including an apparent angular offset from the light beam and/or an apparent distance from the viewing location.

13. The identity authentication system of claim 12, wherein the reference image is selectable from a plurality of reference images based on the apparent target location.

14. (canceled)

15. (canceled)

16. The identity authentication system of claim 9, wherein the light beam generator is a laser, the identity authentication system further including a beam expander configured to expand the light beam to form an expanded light beam, a beam diameter of which is substantially close to a diameter of the eye.

17. A computer-readable medium that stores executable instructions that, when executed, cause one or more processors to perform operations comprising:
recording a reference image using a retinal reflection of an authorized user, wherein the retinal reflection is incident on a hologram to generate the reference image;
projecting a light beam on to a retina associated with an identity of a user;
guiding a reflected light beam, reflected from the retina of the user, on to the hologram;
generating an input image based on the reflected light beam incident on the hologram; and
authenticating the identity of the user as the authorized user based on a comparison of the reference image and the input image.

18. The computer-readable medium of claim 17, wherein recording the reference image comprises:
projecting the light beam on to a reference retina of the authorized user;
generating the reference image by guiding the retinal reflection on to the hologram.

19. The computer-readable medium of claim 18, further comprising:
providing a visual target for the reference retina of the authorized user, the visual target having an apparent target location relative to the reference retina;
changing the apparent target location of the visual target to a reference position; and
recording the reference image when an eye of the authorized user focuses on the visual target.

20. The computer-readable medium of claim 19, wherein recording the reference image includes recording the reference image only when an apparent target position is at the apparent target location.

21. The computer-readable medium of claim 19, wherein changing the apparent target location includes modifying a position of one or more lenses relative to the visual target to change an apparent distance from the eye and/or an angular offset relative to the light beam.

22. A method for authenticating an identity of a user, the user having an eye, the method comprising:
projecting, by a light beam generator, a light beam on to the eye of the user such that a reflected light beam is generated from a reflection of the light beam from the eye of the user;
directing, by an optical system, the reflected light beam such that an input image is formed;
detecting, by an image sensor, the input image formed by the reflected light beam;
determining, by an authenticator, aberration data related to an optical aberration of the eye of the user from the input image;
granting, by the authenticator, authentication for the user when the aberration data is determined to substantially match reference aberration data.

23. (canceled)

24. The method of claim 22, directing, by the optical system, the reflected light beam such that the input image is formed comprises directing the reflected light on to a holographic medium.

25. (canceled)

26. (canceled)

27. The method of claim 22, further comprising:
determining a user accommodation of the eye of the user; and
granting, by the authenticator, authentication for the user only when the reference aberration data corresponds an accommodation approximately equal to the user accommodation.

28. An identity authentication system configured to authenticate a user, the user having an eye, the identify authentication system comprising:
a light beam generator, configured to generate a light beam;
an image sensor configured to sense an input image based on a reflected light beam, wherein the reflected light beam is generated from a reflection of the light beam from the eye of the user;
an optical system, configured to project the light beam onto the eye and to direct the reflected light beam to form the input image at the image sensor; and
an authenticator configured to grant authentication for the user based on optical aberration data related to the eye of the user, wherein the optical aberration data is determined from the input image by the authenticator.

29. The identity authentication system of claim 28, further comprising a holographic medium,
wherein the optical system is configured to direct the reflected light beam towards the holographic medium, and an interaction between the reflected light beam and the holographic medium forms the input image.

30. (canceled)

31. (canceled)

32. (canceled)

33. (canceled)
